(19) United States
(12) Patent Application Publication
(10) Pub. No.: US 2026/0193067 A1
(43) Pub. Date: Jul. 9, 2026

(54) COLLAPSIBLE SHIPPING CONTAINER ACTUATING SYSTEM

(71) Applicant: GenFlat Holdings Inc., Tooele, UT (US)

(72) Inventors: Joseph John Maggio, Tooele, UT (US); Drew D. Hall, Tooele, UT (US)

(73) Assignee: GenFlat Holdings Inc., Tooele, UT (US)

(21) Appl. No.: 19/009,480

(22) Filed: Jan. 3, 2025

(51) Int. Cl. B66F 9/14; B65D 88/52

(52) U.S. Cl. CPC B66F 9/14; B65D 88/52

(57) ABSTRACT

A system for collapsing a shipping container using a forklift vehicle has a forklift extension having first and second parallel hollow rectangular tubes having respective open first ends, and a spreader bar positioned between the rectangular tubes at said open first ends. A support bar is attached to the rectangular tubes at the opposite end, and a wheel frame is attached to the support bar. On each side of the wheel frame is a mounting bracket that includes an axle. Wheels on the axles are used to push open the shipping container wall when the extension is positioned on the forklift, eliminating the need for a separate container spreader.

### BACKGROUND

Collapsible shipping containers represent a significant innovation in the logistics and efficiency of the shipping industry, offering a range of benefits that enhance operational efficacy and reduce costs. One of the primary advantages of collapsible containers is their ability to optimize space during transportation. When not in use, these containers can be collapsed to a fraction of their original size, allowing shipping companies to maximize the use of available cargo space on ships, trucks, and trains. This efficient use of space not only reduces transportation costs but also lowers the carbon footprint associated with shipping operations, making it a more environmentally friendly option.

In addition to space optimization, collapsible shipping containers contribute to improved inventory management and storage solutions. Traditional shipping containers can take up significant space at ports and warehouses when not in use. By incorporating collapsible designs, businesses can minimize the footprint of unused containers, freeing up valuable real estate for other operations. This flexibility allows companies to adapt more readily to fluctuating demand, ensuring that they can scale their operations up or down without the burden of excess, unused equipment. Furthermore, the ease of transport and storage of these containers can lead to faster turnaround times at ports, enhancing overall supply chain efficiency.

Finally, the durability and modularity of collapsible shipping containers provide additional benefits in terms of cost savings and adaptability. Made from robust materials, these containers are designed to withstand the rigors of shipping while also being easily assembled and disassembled. This capability allows shipping companies to quickly respond to changing market conditions by adjusting their container fleet as needed. Additionally, the modular nature of collapsible containers can facilitate innovative uses beyond traditional shipping, such as temporary storage solutions or modular construction projects. Overall, the adoption of collapsible shipping containers can lead to a more agile, sustainable, and cost-effective shipping industry.

Applicants developed a state-of-the-art collapsible shipping container as set forth in U.S. patent application No. 8,113,372, the content of which is incorporated herein by reference. To actuate the collapsible container, a sophisticated machine called a “spreader” was used (see U.S. Patent Publication No. 2008/0011742, the content of which is incorporated herein by reference). However, not all ports were equipped with the spreader. The present invention allows the collapse of the shipping container of the '372 Patent and its kind without the need for a spreader.

### SUMMARY OF THE INVENTION

The present invention is a modification of a forklift vehicle that includes two rectangular tubes that fit over the two forks of the forklift vehicle. The rectangular tubes are connected by a rectangular cap and a support spacer or spreader bar. The rectangular cap is attached to a bracket that mounts two axels, one on each side of the bracket. On the axels is a wheel of rubber or synthetic material that is soft enough not to mar the surface of the container but robust enough to withstand multiple loadings without appreciable wear.

The device is placed on the forklift by inserting the two forks of the forklift into the rectangular tubes, which positions the bracket in front of the forklift at the height of the forks. The wheels are the distal most point of the bracket, such that when the forklift is moved toward the shipping container, the wheels make contact with the wall of the container. The forklift operated can raise the forks to the appropriate height, and then the forklift is driven forward, causing the device to push against and rotate the wall of the shipping container upwardly against the ceiling of the container. The wheels rotate as the wall pivots upward, and the forklift operator raises the forks as the wall is driven into the locking position on the ceiling. Once the forklift locks the wall against the container's ceiling, the forklift is withdrawn. The same procedure in reverse can be used to expand the shipping container.

These and other features of the invention will best be understood with reference to the accompanying drawings and the detailed description of the invention set forth below.

### BRIEF DESCRIPTION OF THE DRAWINGS

FIG. 1 is an elevated, perspective view of the present invention;

FIG. 2 is a side view, partially in cross section, of the present invention;

FIG. 3 is a side view, partially in cross section, of the actuation of the shipping container door;

FIG. 4 is an elevated, perspective view of the forklift attachment;

FIG. 5 is a front view of the attachment of FIG. 4;

FIG. 6 is a top view of the attachment of FIG. 4; and

FIG. 7 is a side view of the attachment of FIG. 4.

### DETAILED DESCRIPTION OF THE PREFERRED EMBODIMENTS

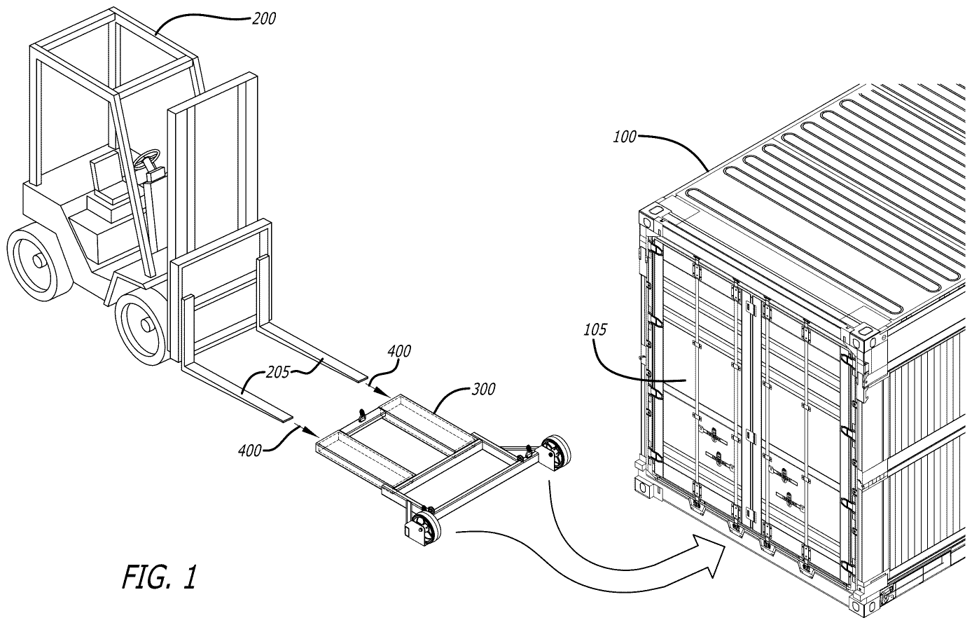

FIG. 1 illustrates a system for actuating a collapsible shipping container 100 using a forklift vehicle 200 and a removable extension 300. The shipping container has two end doors that rotate upward to lock against the ceiling of the container. Once locked against the ceiling, the container may be collapsed into a configuration less than one third the expanding volume. Forklifts 200 are common in shipping yards and include two forks 205 that are used to slip under a pallet and lift cargo onto ships, trains, trucks, and the like. Because pallets are fairly standard, the distance between forks is also typically standard for most forklifts 200. As indicated by arrows 400, the extension 300 is placed in front of the forklift 200 and the forklift is driven forward until the forks 205 are captured in the extension 300. Once the extension is secure on the forklift forks, the system can be used to lock and unlock the container doors.

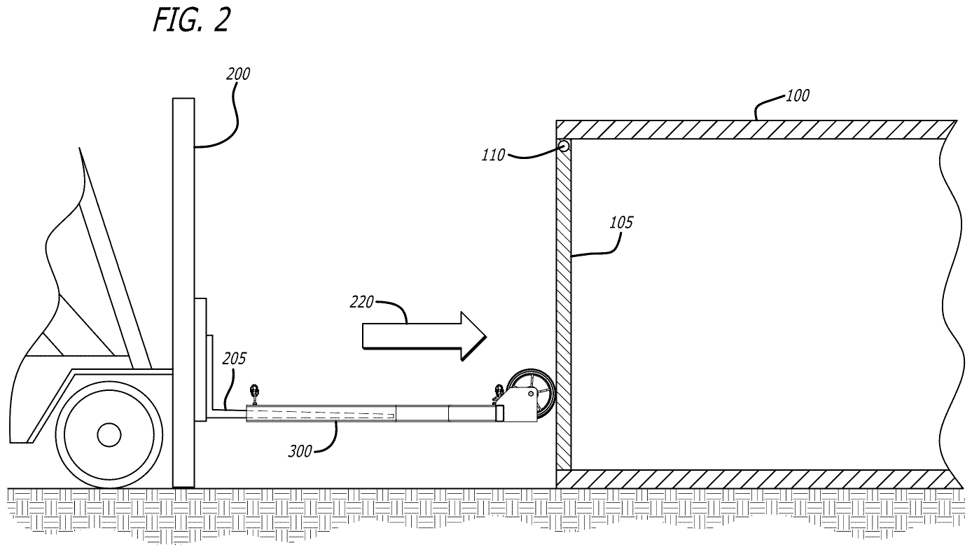

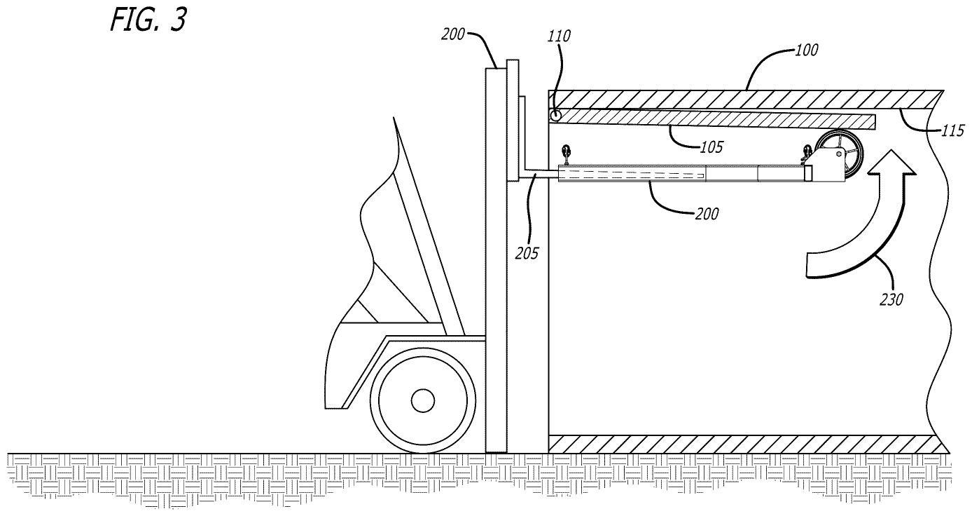

FIGS. 2 and 3 show the sequence for actuating the container door once the extension 300 is loaded on the forklift 200. The forklift is operated to raise the forks 205 so that the extension is proximate the container door 105 at a height that is approximately one quarter the total height of the door 105. The forklift is then driven forward (see arrow 220), causing the door 105 to pivot about its pin 110 inwardly by the force applied by the forklift 200. As the door pivots upward (see arrow 230), the forks are raised and moved inward until the door 105 comes into contact with the ceiling 115. The locking mechanism on the ceiling is omitted for clarity. To unlock the door 105, the steps are reversed.

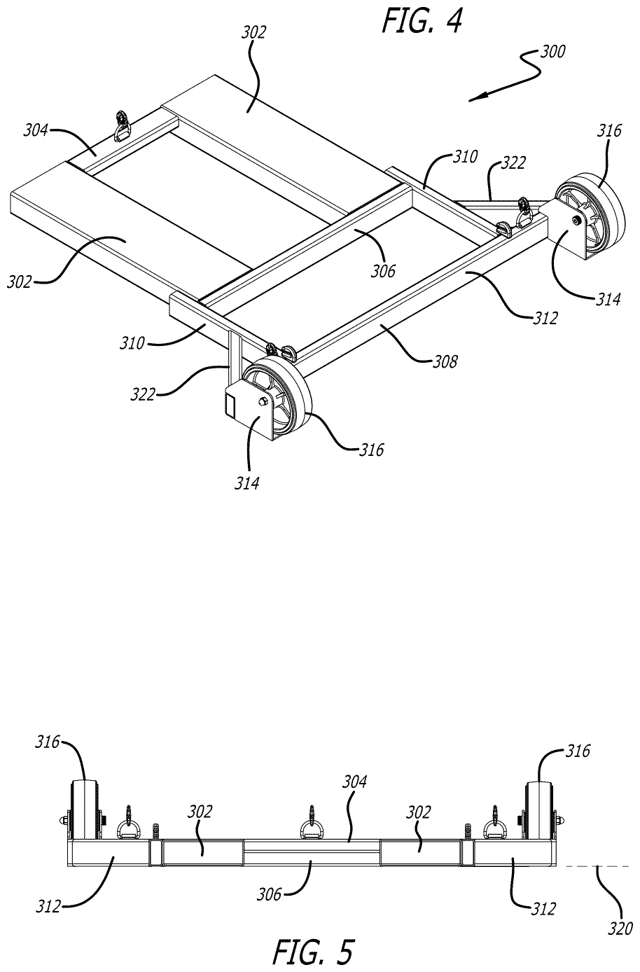

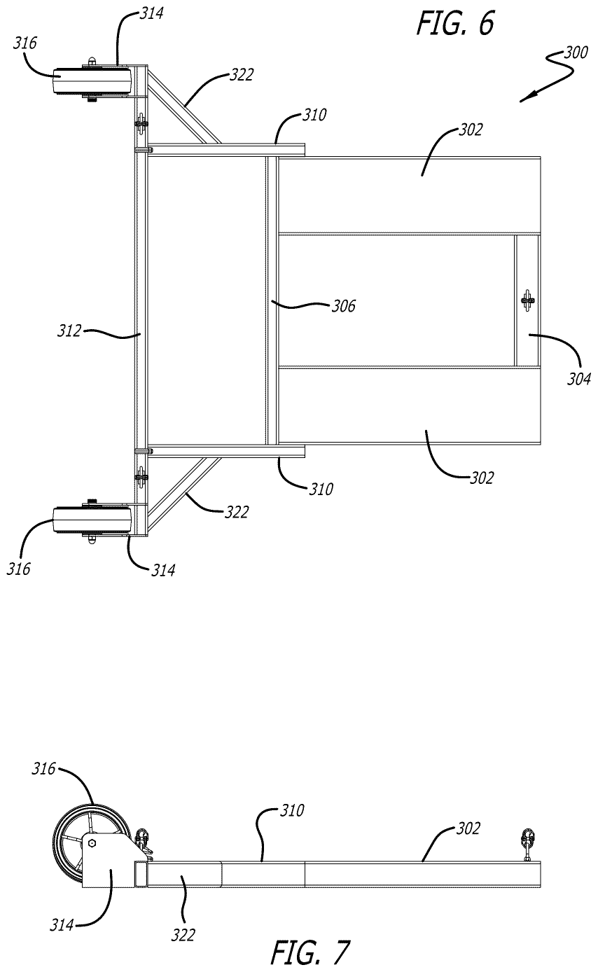

FIGS. 4-7 illustrate the extension 300 used to rotate the container door 105. The extension is a sturdy, metal framed construction that can support the weight of the container door without deflection or deforming. The proximal end includes two parallel hollow rectangular tubes 302 that are open at the proximal end so that the tubes may receive the forks of the forklift. To support the tubes 302 at the proximal end, a spreader bar 304 is positioned between the two tubes. A D-ring may be attached to the top of the spreader bar 304 for more convenient carrying of the unit. At the opposite end of the tubes 302 is a support bar 306 having the same width as the width of the two tubes 302. The support bar 306 caps the hollow tubes 302 at the distal end, such that the forks of the forklift can approach or make contact with the support bar 306 when the forks are fully inserted into the tubes 302.

A wheel frame 308 is attached to the support bar 306 and sandwiched by two parallel arms 310 attached to a transverse wheel spacer member 312 extending horizontally outwardly of the arms 310, such that the arms, support bar 306, and wheel spacer member 312 form an open rectangle. Two mounting brackets 314 are affixed to respective ends of the wheel spacer member 312. Each mounting bracket 314 includes a journaled axle that are colinear, and each axle carries a respective wheel 316. As best seen in FIG. 5, the wheels are positioned to be tangent to a plane defined by the lower surface 320 of the wheel frame 308 and project from their respective mounting brackets in vertical (see FIG. 5) and horizontal (see FIG. 7) directions. In a preferred embodiment, the wheels have a diameter that is three times the thickness of the wheel frame 308. D-rings can be also be attached to the support bar 306 so that the attachment 300 can be lifted by straps by the forklift when needed.

For additional support, the wheel frame 308 can include first and second diagonal braces 322 that buttress the wheel spacer member 312.

While the attachment has been shown and described at to the inventors'preferred embodiments, the invention is not limited to those embodiments depicted. A person of ordinary skill in the art will readily recognize certain modifications, substitutions, and alternations, and the invention's scope is intended to include all such deviations from the preferred embodiments. Accordingly, the invention is properly construed by reading the appended claims using their ordinary meanings, consistent with but not limited by the drawings and descriptions above.

We claim:

1. A forklift extension for actuating a collapsible shipping container, comprising:
first and second parallel hollow rectangular tubes having respective open first ends;
a spreader bar positioned between the rectangular tubes at said open first ends;
a support bar attached to the rectangular tubes at ends opposite to said open first ends;
a wheel frame attached to the support bar, said wheel frame comprising first and second parallel arms connected to a transverse wheel spacer member extending horizontally outwardly of the first and second parallel arms;
first and second mounting brackets attached respectively to first and second ends of the wheel spacer member;
a first axle journaled in the first mounting bracket and a second axle journaled in the second mounting bracket, said first and second axles spaced apart and colinear; and
first and second wheels, each wheel mounted on a respective axle;
wherein said wheels are positioned to be tangent to a plane defined by a lower surface of the wheel frame and project from their respective mounting brackets in a vertical and horizontal direction.

2. The forklift extension of claim 1, wherein a diameter of each wheel is three times a thickness of the wheel frame.

3. The forklift extension of claim 1, wherein the wheel frame and the support bar cooperate to form an open rectangle.

4. The forklift extension of claim 1, further comprising a first diagonal brace connecting the wheel frame with the first mounting bracket, and second diagonal brace connecting the wheel frame with the second mounting bracket.

5. The forklift extension of claim 1, wherein the rectangular tubes, spreader bar, support bar, and wheel frame all have a common thickness, and whose upper and lower surfaces define an upper and lower plane.
